(19) United States
(12) Patent Application Publication
(10) Pub. No.: US 2026/0116462 A1
(43) Pub. Date: Apr. 30, 2026

(54) Feedforward Torque Tracking Control

(71) Applicant: Steering Solutions IP Holding Corporation, Saginaw, MI (US)

(72) Inventors: Vidit V. Pandya, Rochester Hills, MI (US); Aayush Singh, Saginaw, MI (US); Michael S. Wyciechowski, Grand Blanc, MI (US); Jeffrey R. Meyer, Munger, MI (US); Joel E. Birsching, Vassar, MI (US); Roshan A. Chavan, Essexville, MI (US); Michael A. Eickholt, Chesaning, MI (US)

(21) Appl. No.: 19/342,883

(22) Filed: Sep. 29, 2025

Related U.S. Application Data
(60) Provisional application No. 63/711,728, filed on Oct. 25, 2024.

(51) Int. Cl. B62D 5/04; B62D 6/00

(52) U.S. Cl. CPC B62D 5/0463; B62D 6/008

(57) ABSTRACT

A system for controlling a steering system includes a processor and a memory including instructions that, when executed by the processor, cause the system to receive a handwheel position value, generate an estimation of system inertia based on a handwheel acceleration value obtained using the handwheel position value, obtain, based on the estimation of system inertia and a reference torque and without using a torque measurement received from a torque sensor, a handwheel torque command value, and control at least one component of the steering system based on the handwheel torque command value.

### CROSS REFERENCE TO RELATED APPLICATIONS

The present disclosure claims priority to U.S. Provisional Application No. 63/711,728, filed on Oct. 25, 2024. The entire disclosure of the application referenced above is incorporated herein by reference.

### TECHNICAL FIELD

This disclosure relates to handwheel actuators (HWAs) for steer-by-wire (SbW) steering systems.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

A system for controlling a steering system includes a processor and a memory including instructions that, when executed by the processor, cause the system to receive a handwheel position value, generate an estimation of system inertia based on a handwheel acceleration value obtained using the handwheel position value, obtain, based on the estimation of system inertia and a reference torque and without using a torque measurement received from a torque sensor, a handwheel torque command value, and control at least one component of the steering system based on the handwheel torque command value.

In other aspects, one or more systems, processors or processing devices, computing devices, etc. are configured to perform functions corresponding to steps of various methods described herein.

In other aspects, a tangible, non-transitory computer-readable medium stores instructions that, when executed, cause one or more processors or processing devices to perform any operation of any method described herein.

In other aspects, one or more methods may be implemented to perform functions corresponding to systems described herein.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 2A generally illustrates an example rack or roadwheel actuator (RWA) controller and column or handwheel actuator (HWA) of a steering system.

FIG. 2B generally illustrates functional architecture for the system of FIG. 2A.

FIG. 2C generally illustrates an example block diagram representation of a sensor-based model.

FIG. 2D generally illustrates an example block diagram representation of a sensor-based model according to the principles of the present disclosure.

FIG. 3A generally illustrates an example HWA controller of a steering system according to the principles of the present disclosure.

FIG. 3B illustrates an example feedforward torque control architecture according to the principles of the present disclosure.

FIG. 3C illustrates an example feedforward torque control algorithm according to the principles of the present disclosure.

FIG. 4 is a flow diagram generally illustrating a method for performing feedforward torque tracking control techniques according to the principles of the present disclosure.

### DETAILED DESCRIPTION

The following discussion is directed at various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

A SbW steering system may include at least one handwheel actuator (HWA), such as a steering wheel, which is used by a driver to control the vehicle laterally, and at least one roadwheel actuator (RWA), which is used to control a steered axle of the vehicle and create lateral motion of the vehicle responsive to movement of the HWA. A SbW steering system may further include a controller, such as a domain or other type of controller, configured to store and execute control logic to control various components of the SbW steering system.

Example HWAs of SbW steering systems may implement closed loop effort control techniques by using a torsion bar (T-bar)-based torque sensor (a handwheel torque sensor) to determine driver torque and provide accurate torque tracking. However, electromechanical torque sensing techniques increase cost and control challenges for HWA systems. Further, various instabilities associated with the torsion bar may include, but are not limited to: phase lag introduced by torsional compliance; resonance due to spring behavior; measurement noise; non-linear stiffness; and material temperature sensitivity.

Steering systems and methods according to the present disclosure are configured to implement HWA control techniques without a torque sensor (e.g., without a T-bar-based torque sensor). For example, the described systems and methods implement feedforward torque tracking control. Without a torque sensor, there is no measurement of feedback into the controller, requiring feedforward effort control techniques. For example, a reference effort torque command can be converted directly to a motor torque command to account for mechanical ratios and efficiencies. Control system parameters can be calibrated/adjusted to ensure steer feel requirements are met. By performing feedforward control without a torque sensor, HWA control according to the present disclosure may increase performance and reduce cost.

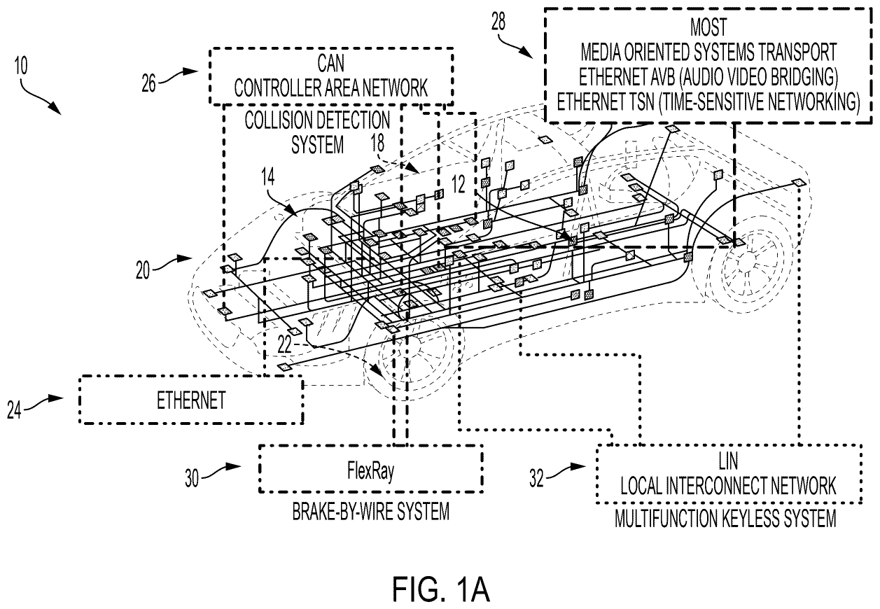

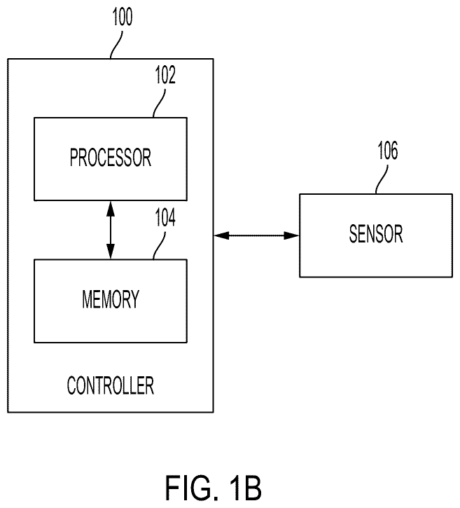

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position (which can be used to obtain handwheel acceleration), an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10. The steering system of the present disclosure is configured to implement control techniques as described below in more detail.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B. In some examples, one or more functions may be performed remotely (e.g., relative to the vehicle), such as at a controller, processor, circuitry, etc. of a remote server, cloud computing system, and/or other remote processing system.

In some embodiments, the controller 100 may perform the methods described herein. However, the methods described herein as performed by the controller 100 are not meant to be limiting, and any type of software executed on a controller, processor, or other circuitry can implement the SbW control techniques described herein without departing from the scope of this disclosure. For example, a controller, such as a processor executing software within a computing device, can implement the systems and methods described herein.

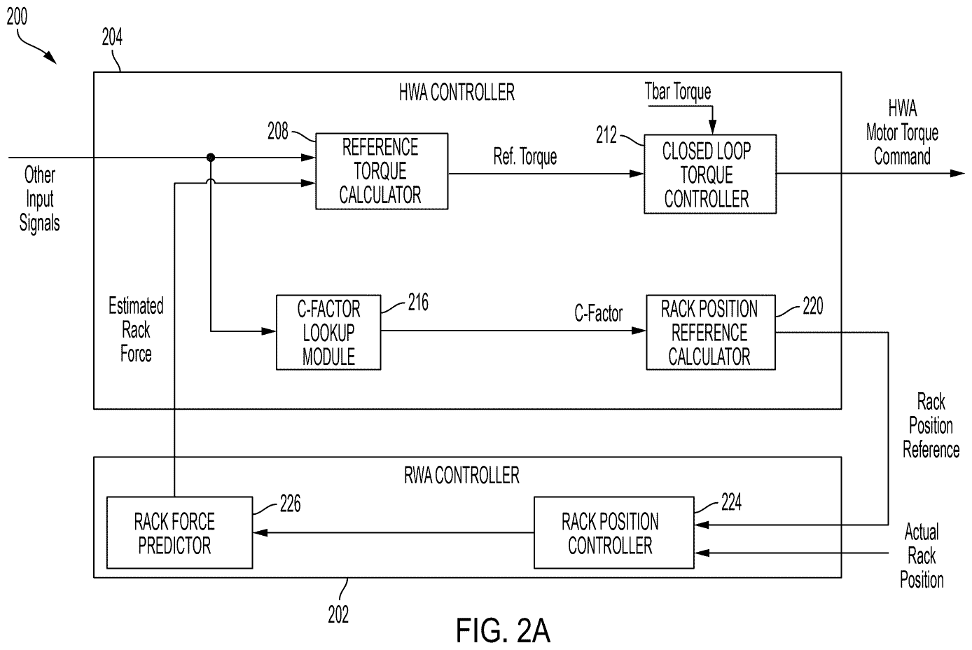

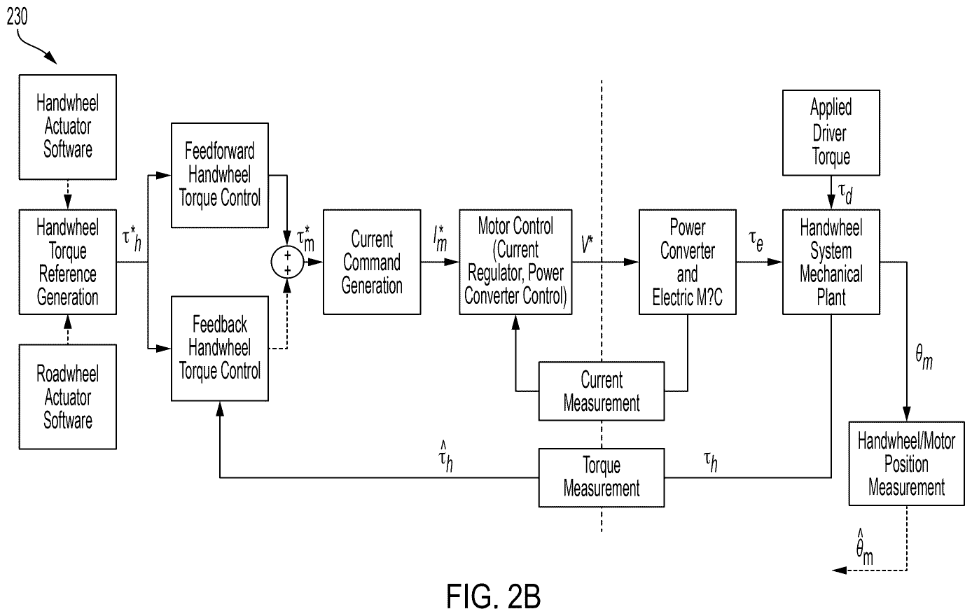

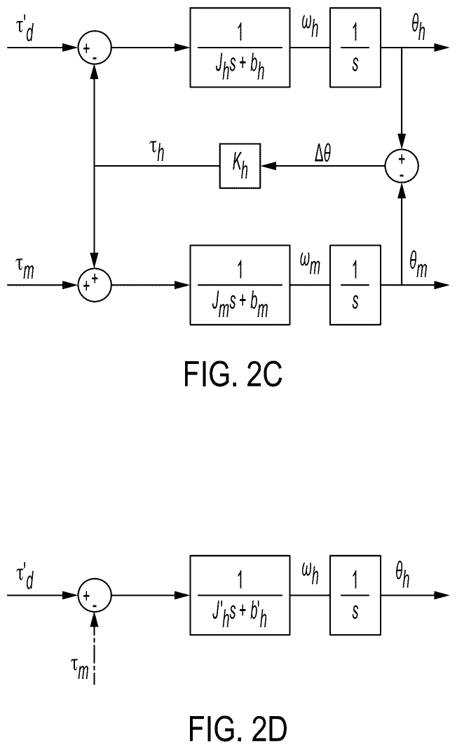

FIG. 2A illustrates an example steering system 200 including a rack or RWA controller 202 and column or handwheel actuator (HWA) controller 204 of a steering system configured to implement HWA control techniques using a torque sensor (e.g., without a T-bar-based torque sensor). The HWA controller 204 is configured to generate a handwheel actuator (HWA) motor torque command based on an estimated rack force (e.g., an estimated rack force signal) received from the RWA controller 202 and one or more other input signals (e.g., vehicle speed, handwheel position, and handwheel velocity). The RWA controller 202 is configured to determine the estimated rack force based on the motor torque required to achieve or maintain an actual rack/roadwheel position. The controllers 202 and 204 may correspond to, be implemented by, etc. one or more steering system controllers.

As one example, the HWA controller 204 includes a reference torque calculator 208 configured to calculate a reference torque (Tref) based on the estimated rack force and the one or more other input signals. For example, the reference torque corresponds to a sum of various inputs/measurements such as effort, hysteresis, return correction or CVR, damping, catch, etc. A closed loop (e.g., a PID closed loop) torque controller 212 is configured to generate and output the motor torque command based at least in part on a force or torque applied by the driver (e.g., “T-bar torque,” as provided by a torque sensor) and the reference torque. The motor torque command is provided as a control signal to control a motor of the handwheel actuator.

The estimated rack force corresponds to the measured or estimated roadwheel actuator motor torque. Accordingly, the estimated rack force (and any estimated rack force offset or error) is a critical factor for determining the force provided by the motor of the handwheel actuator.

In some examples, the HWA controller 204 may further include a C-factor lookup module 216 and a rack position reference calculator 220. For example, the rack position reference calculator 220 is configured to generate the rack position reference based on a C-factor received from the C-factor lookup module 216. The C-factor may be determined based on a handwheel angle (“HwAg”) corresponding to driver input (e.g., a handwheel angle indicating driver intent conveyed via the handwheel) and vehicle speed. Example systems and methods for obtaining the rack position reference and the C-factor are described in more detail in U.S. patent application Ser. No. 18/318,657, filed on May 16, 2023, the entire contents of which are incorporated herein by reference.

The RWA controller 202 includes a rack position controller 224 (e.g., a PID rack position controller) configured to generate one or more rack position control signals based on the actual rack position and the rack position reference (e.g., a rack position error based on a difference between the actual rack position and the rack position reference). For example, the rack position control signals may include, but are not limited to, rack motor velocity and motor torque command (e.g., indicative of an amount of torque applied by the driver) signals. In this manner, rack position is controlled to follow the intent of the driver (as indicated by the rack reference position). In some examples, the rack position controller 224 may be configured to control rack position further based on a target rack position. For example, the rack position reference may correspond to an ideal/desired steering response. Conversely, the target rack position may correspond to an actual target position to which the steering rack should move. In other words, the target rack position may be determined based in part on the rack position reference but may be adjusted or limited in accordance with hardware or software limitations, vehicle dynamics, safety, etc.

A rack force predictor 226 generates the estimated rack force based on outputs of the rack position controller 224 (e.g., based on a function of the rack motor velocity, the rack motor torque command, etc.). In various examples, the estimated rack force can be used to provide handwheel torque resistance to the driver via the HWA. As shown, the rack force predictor 226 may output the estimated rack force and the reference torque calculator 208 (and/or another component of the RWA controller 202, the HWA controller 204, etc.) may obtain an estimated rack load based on the estimated rack force. In other examples, the rack force predictor 226 may output the estimated rack load. In some contexts, the terms “estimated rack force” and “estimated rack load” may be used interchangeably.

For example, for RWA position control, the rack position reference signal (“RackPosRef”) may be calculated based on a position error (“PosErr”) between an ADAS rack position reference value or signal (“ADASRackPosRef”) and an HWA rack position reference value or signal (“HWARackPosRef”). Conversely, HWA position control is based on a position error between the HWA position and the RWA position, such that the handwheel can be controlled to rotate in a manner consistent with rotation of the roadwheel in hands-off conditions.

The reference torque may correspond to a desired, ideal, or target torque to be felt by the driver (i.e., at the handwheel/steering wheel). As described above, the reference torque is calculated based on inputs including, but not limited to, driver input (e.g., an input torque, corresponding to steering handwheel angle), road conditions, damping, hysteresis, etc. A torque at the handwheel is controlled (e.g., via the HWA) to match the reference torque. For example, outputs of one or more sensors measuring actual torque at the wheel are used to minimize the difference between the reference torque and the actual torque.

An effort function (e.g., an effort function implemented by the reference torque calculator 208) defines a relationship between driver input (e.g., the force or torque applied by the driver to the handwheel, which may be referred to as “effort”) and a response (i.e., movement) of the steering system. For example, the effort function may output an effort value based on a lookup table or other function (e.g., by using an estimated rack load as an input). The estimated rack load may be modified prior to being input to the lookup table by adding a calculated return load value to the estimated rack load. The effort function indicates an amount of effort required by the driver to cause a desired response.

A general higher level functional architecture 300 for the system 200 is shown in FIG. 2B. The two primary modes of control within such a handwheel actuator are the current control loop and the torque control loop. Torque control is performed by utilizing feedback from torque sensor, or by implementing feedforward control in absence of torque sensing or as a redundant mode during torque sensor failure. The torque regulator acts on the reference torque command requested by the SbW system to generate a motor torque command. The motor torque command is then converted to an equivalent current command which is further regulated based on the measured current to generate a voltage command.

The torsion bar torque (which may be referred to as handwheel torque) signal is sensed via a torque sensor present on the lower end of the torsion bar, however, it does not provide information solely on the torque applied by the driver. This makes it challenging to estimate the driver torque precisely. Similarly for steering configurations that do not employ a torsion bar and hence a torque sensor, driver torque estimation is equally (if not more) challenging due to absence of any sensing mechanism. Accurately estimating driver torque is crucial for modern steering applications as multiple ADAS functions rely on the driver torque signal as a primary input.

In some embodiments, example systems and methods may be configured to provide a generalized minimally realizable linear state observer for driver torque applicable to different steering configurations. Further, two specific observer gain tuning strategies that allow easier and intuitive tunability may be used.

An example general model for the handwheel actuator mechanical system may be given as:

$${τ}_{d} - {τ}_{f} = {J}_{h} {\ddot{θ}}_{h} + {b}_{h} {\dot{θ}}_{h} + {τ}_{r} \qquad ( 1 )$$

where τ_{d}, τᵣ, are the driver and residual torque, respectively. Residual torque may refer to a torque value associated with a torque remaining in steering components after an input force (e.g., handwheel torque) has been removed. For example, the residual torque may be associated with internal resistance or friction within a steering rack, various gears, brushings, and/or the like (e.g., for EPS or the like steering systems). Additionally, or alternatively, with respect to SbW steering systems, the residual torque may be associated with remaining torque or resistance in a steering actuator or feedback motor, after the driver input is removed. The residual torque may be determined based on a sensor measurement and/or estimated, as described herein. Jₕ and bₕ are the mechanical constants (inertia and damping) for the handwheel and θₕ is the handwheel angle or position. \dot{θ}ₕ is handwheel speed and \ddot{θ}ₕ is handwheel acceleration. τ_{f} is the lumped/combined friction term as a function of Coulomb friction, aerodynamical drag, and other friction components that may act on the handwheel based on the design.

For simplicity in modeling, the driver torque and friction component can be lumped together as

$${τ}_{d}^{′} ,$$

hence:

$${τ}_{d}^{′} = {τ}_{d} - {τ}_{f} \qquad ( 2 )$$

Equivalently, it may be assumed that analytically modeled τ_{f} may be lumped within τ_{d} for simplicity in modeling. Hence the transfer function for handwheel angle (position) θₕ may be written as:

$${θ}_{h} = \frac{1}{{J}_{h} {s}^{2} + {b}_{h} s} ( {τ}_{d}^{′} - {τ}_{r} ) \qquad ( 3 )$$

Based on the general model, different cases may be modeled based on application. For sensor-based SbW or EPS applications, the handwheel actuator mechanical system for a T-bar based system can be represent as a 2-mass model. The governing equations for the 2-mass model are as follows:

$${τ}_{d}^{′} - {τ}_{h} = {J}_{h} {\ddot{θ}}_{h} + {b}_{h} {\dot{θ}}_{h} \qquad ( 4 )$$

$${τ}_{h} = {K}_{h} ( {θ}_{h} - {θ}_{m} )$$

$${τ}_{m} + {τ}_{h} = {J}_{m} {\ddot{θ}}_{m} + {b}_{m} {\dot{θ}}_{m}$$

where τₕ, τₘ are the handwheel and motor torque respectively. θₘ is the motor angle in the handwheel frame of reference. Jm and bm are the mechanical constants (inertia and damping) for the motor, in the handwheel frame of reference. Kₕ is the T-bar compliance. Note that for this case τₕ is equivalent to tr (residual torque).

For this case the handwheel angle may be estimated from eq. 4, as

$${\hat{θ}}_{h} = \frac{{\hat{τ}}_{h}}{{\hat{K}}_{h}} + {\hat{θ}}_{m} \qquad ( 5 )$$

An example block diagram representation of the sensor-based model is shown in FIG. 2C.

For sensorless SbW or EPS applications, the handwheel actuator mechanical system for a T-barless system may be presented as a 1-mass model and may be written as follows:

$${τ}_{d}^{′} - {τ}_{m} = {J}_{h}^{′} {\ddot{θ}}_{h} + {b}_{h}^{′} {\dot{θ}}_{h} \qquad ( 6 )$$

Note that for a sensorless system, due to high column stiffness the handwheel angle and motor angle in handwheel frame of reference are the same. Furthermore,

$${J}_{h}^{l}$$

and

$${b}_{h}^{′}$$

represent the lumped inertia and damping terms to account for both handwheel and motor parameters. Here τₘ is equivalent to the residual torque.

In some embodiments, example systems and methods described may be configured to provide a minimally realizable state observer. The generalized handwheel actuator system can be represented as a combination of three states, the handwheel angle, handwheel velocity and driver torque. However, it can also be represented as a minimal realization with just two states by eliminating handwheel angle. A minimal realization is a representation of a system with the least number of state variables without losing information on the system behavior. Such a representation ensures that the observer can estimate the state with precision with the minimum amount of system information. Hence an observer design based on such a system representation can be generalized to many applications as it can be implemented with the lowest number of measurements possible.

An example block diagram representation of a sensorless model is shown in FIG. 2D.

Steering systems and methods according to the present disclosure are configured to implement feedforward HWA control (e.g., HWA torque tracking) techniques without a torque sensor (e.g., in accordance with a sensorless model) as described below in more detail. Torque tracking techniques as described herein can be achieved via feedforward torque control without the use of a torque sensor for feedback. For example, a reference torque command that is received from upstream components (e.g., an Effort command sum) is used as the primary torque input to an HWA torque controller (e.g., a feedforward torque controller) and is then compensated in view of system inertia (represented by a partial state feedback term) before being converted to the HWA motor torque command.

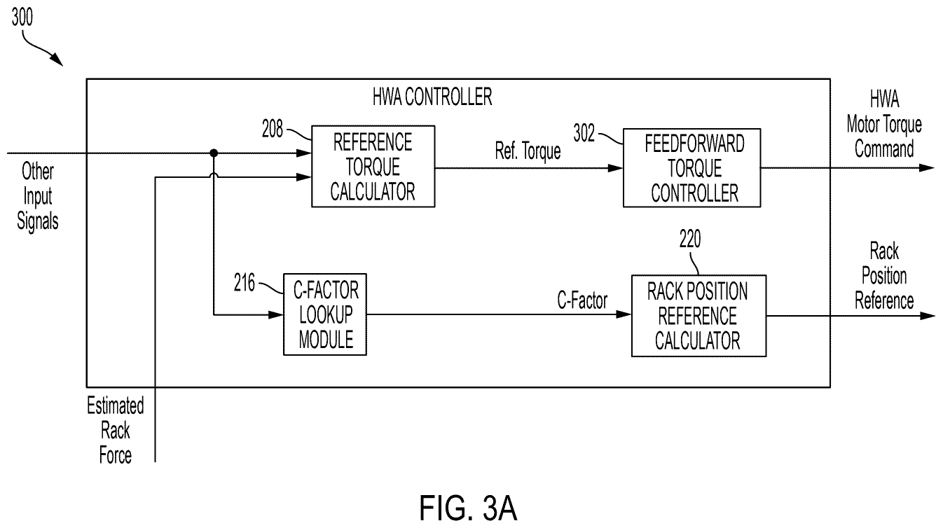

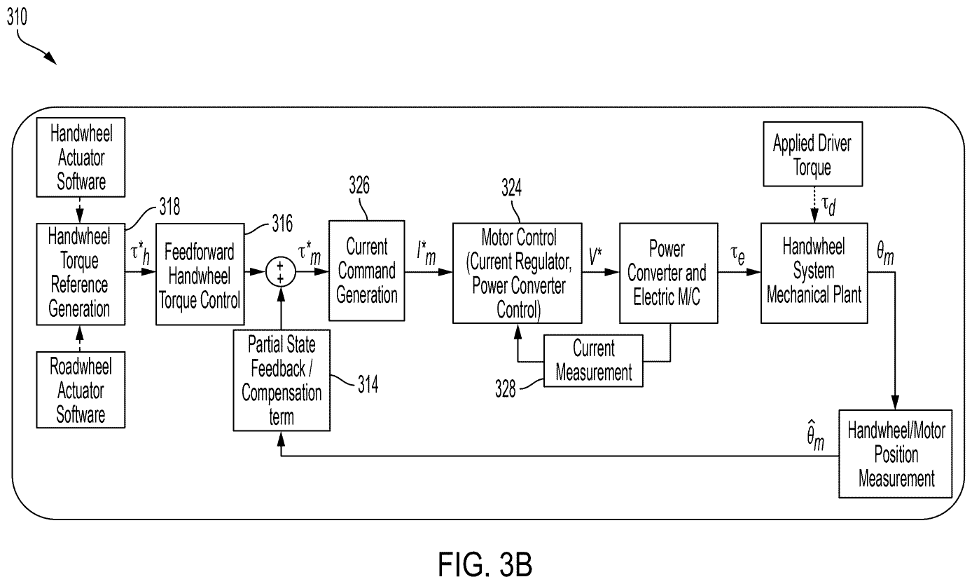

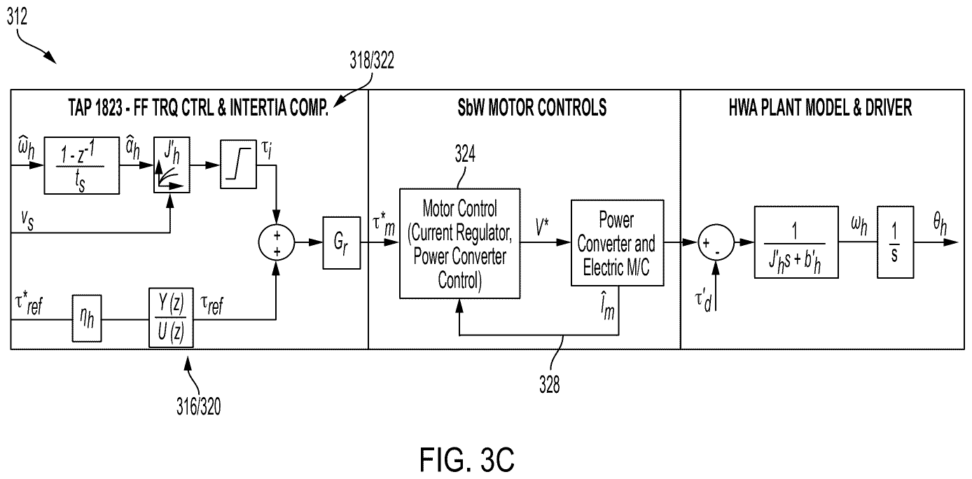

FIG. 3A shows an example HWA controller 300 including a feedforward torque controller 302 configured to control HW torque based on a driver effort torque sum and reference torque command according to the principles of the present disclosure. For example, various components of the HWA controller 300 provide various inputs (e.g., from lookup tables, algorithms, models, etc., based on vehicle speed) to determine a primary output of a function to generate the driver effort torque sum. In examples using position-based effort, a separate lookup table may be used for a degraded mode where rack force estimate is not available. Notably, the feedforward torque controller 302 does not include or receive inputs from a T-bar torque sensor. The HWA controller 300 may otherwise be similar to, and perform similar functions as, the HWA controller 200. For example, the HWA controller 300 may include the reference torque calculator 208, C-factor lookup module 216, rack position reference calculator 220, etc.

FIG. 3B shows an example feedforward torque control architecture 310 implemented by the feedforward torque controller 302. FIG. 3C shows an example feedforward torque control algorithm 312 implemented by the architecture 310. In contrast to the architecture 230 shown in FIG. 2B, the architecture 310 does not receive a torque measurement (i.e., a torque measurement received from a torque sensor). Instead, a partial state/feedback compensation term (partial state feedback) 314 is derived in accordance with a handwheel/motor position measurement or angle \hat{θ}ₘ and feedforward control is performed based on the partial state feedback. Feedforward control using partial state feedback can expressed mathematically as

$${τ}_{h} = {τ}_{r e f} - {J}_{h}^{*} {\ddot{θ}}_{h} \qquad ( 7 )$$

where τ_{ref} represents a calculated reference handwheel torque (or, effort), and

$${J}_{h}^{*} {\ddot{θ}}_{h}$$

is the partial state feedback term. τ_{ref} is a part of a larger control loop that includes the RWA and HWA systems, and is based on the observed rack force generated by the movement of the rack, which is governed by the handwheel position generated due to the applied torque and driver inputs. Represented schematically in FIG. 3B, a feedforward handwheel torque control block 316 receives a reference handwheel torque from a handwheel torque reference generation block 318, and the output of the block 316 (e.g., a modified reference torque) is combined with the partial state feedback term to obtain a motor torque command (which may be modified in accordance with a gear ratio Gr).

Operations performed by the block 316 are represented at 320 in FIG. 3C. The operations 320 may include modifying/adjusting a received τ_{ref} based on various factors, such as efficiency of a belt drive or gear (represented by ηₕ). Operations performed by the block 318 are represented at 322 in FIG. 3C. The operations 322 may include obtaining an inertial torque term (e.g., an estimated inertia term corresponding to the actual inertia of the system and the partial state feedback term) based on theta_h (corresponding to handwheel angle as described above).

As shown in FIG. 3C, the block 318 outputs a torque inertia term TI, which can be calculated in accordance with the partial feedback term

$${J}_{h}^{*} {\ddot{θ}}_{h}$$

(e.g., using a discrete derivative of handwheel velocity). Handwheel velocity can be obtained using a discrete derivate of the handwheel position (which can be obtained via position sensing of the handwheel actuator). Accordingly, handwheel acceleration is a double derivative of handwheel position.

Outputs of the blocks 316 and 318 (e.g., results of the operations 320 and 322, respectively) are combined and provided to a motor control block 324 as a current command (e.g., by a current command generation block 326 configured to convert a motor torque command to the current command). The block 324 outputs a motor control voltage based on the current command and current feedback (e.g., based on a current measurement 328).

This calculation may assume that: the estimated inertia term is equivalent to the actual inertia of the system; and the actual damping term bₕωₕ is compensated elsewhere (e.g., in software, via a measured system state \dot{θ}ₕ. Based on these assumptions and the handwheel system mechanical plant model, there is an equilibrium at steady state where τ_{d}=τ_{ref}. Further, a compensator (notch) for the reference torque improves robustness for the open loop HWA system. For example, to overcome instabilities in the mechanical plant of the handwheel actuator, a compensator (e.g., a notch filter) for the reference torque may be used. Careful tuning of such a compensator shall ensure that the poles of the plant transfer function remain in the left half plane and the open loop system remains stable for all frequency ranges.

As an example, the partial state feedback term can be tuned as

$${J}_{h}^{*} = {J}_{h}^{′} + {\tilde{J}}_{h}$$

by combining the actual system inertia and an inertia add/subtract term for subjective steering feel. Further, depending on the mechanical configuration, additional friction compensation may also be provided to improve tracking accuracy.

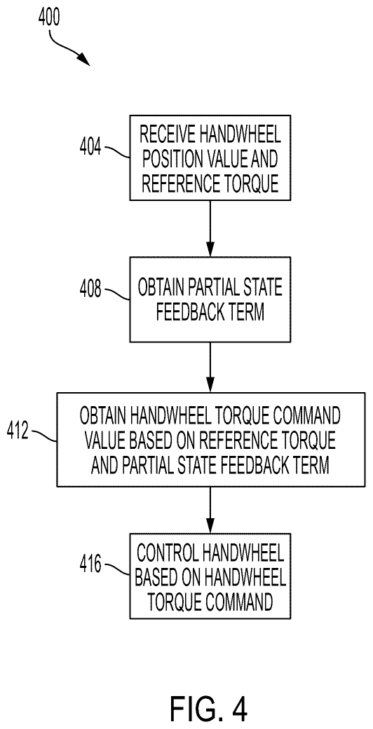

FIG. 4 is a flow diagram generally illustrating a method 400 for performing feedforward torque tracking control techniques according to the principles of the present disclosure. For example, one or more computing devices, processors, or processing devices, etc. are configured to execute instructions to implement the method 400, such as one or more of the processors of the systems described herein (e.g., a computing device or processor of a vehicle configured to implement the controller 100, the controller 300, the architecture 310, etc.). One or more of the steps of the method 400 as described below may be skipped or omitted in some examples, and/or one or more of the steps may be performed in a different sequence than described.

At 404, the method 400 includes receiving a handwheel position/angle value and a reference torque (e.g., a reference torque received from a reference torque calculator as described herein). At 408, the method 400 includes obtaining a partial state feedback term based on the handwheel position value (e.g., a partial state feedback term corresponding to an estimated torque inertia). For example, the handwheel position value can be used to obtain a handwheel acceleration value.

At 412, the method 400 includes obtaining a handwheel torque command value based on the reference torque and the partial state feedback term. In this manner, the reference torque is adjusted to compensate for system inertia (as represented by the partial state feedback term), in the absence of a torque sensor measurement, which can then be converted to a motor (handwheel) torque command. At 416, the method 400 includes controlling the handhweel based on the handwheel torque command value.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A system for controlling a steering system, the system comprising:
a processor; and
a memory including instructions that, when executed by the processor, cause the system to:
receive a handwheel position value;
generate an estimation of system inertia based on a handwheel acceleration value obtained using the handwheel position value;
obtain, based on the estimation of system inertia and a reference torque and without using a torque measurement received from a torque sensor, a handwheel torque command value; and
control at least one component of the steering system based on the handwheel torque command value.

2. The system of claim 1, wherein the reference torque is based on an output of a driver effort function.

3. The system of claim 1, wherein obtaining the handwheel torque command value includes obtaining the handwheel torque command value based on
$${τ}_{h} = {τ}_{r e f} - {J}_{h}^{*} {\ddot{θ}}_{h} ,$$
wherein τₕ is the handwheel torque command value, τ_{ref} is the reference torque, and
$${J}_{h}^{*} {\ddot{θ}}_{h}$$
represents the estimation of system inertia, and wherein \ddot{θ}ₕ corresponds to the handwheel acceleration value and
$${J}_{h}^{*}$$
corresponds to a mechanical constant of inertia associated with a handwheel.

4. The system of claim 1, wherein the steering system is a steer-by-wire (SbW) steering system.

5. The system of claim 1, wherein obtaining the handwheel torque command value includes combining the estimation of system inertia with the reference torque.

6. The system of claim 5, wherein combining the estimation of system inertia with the reference torque includes subtracting the estimation of system inertia from the reference torque.

7. A steering system comprising the system of claim 1.

8. A vehicle comprising the steering system of claim 7.

9. A method for controlling a steering system, the method comprising, using one or more processors:
receiving a handwheel acceleration value;
generating an estimation of system inertia based on the handwheel acceleration value;
obtaining, based on the estimation of system inertia and a reference torque and without using a torque measurement received from a torque sensor, a handwheel torque command value; and
controlling at least one component of the steering system based on the handwheel torque command value.

10. The method of claim 9, wherein the reference torque is based on an output of a driver effort function.

11. The method of claim 9, wherein obtaining the handwheel torque command value includes obtaining the handwheel torque command value based on
$${τ}_{h} = {τ}_{r e f} - {J}_{h}^{*} {\ddot{θ}}_{h} ,$$
wherein τₕ is the handwheel torque command value, τ_{ref} is the reference torque, and
$${J}_{h}^{*} {\ddot{θ}}_{h}$$
represents the estimation of system inertia, and wherein \ddot{θ}ₕ corresponds to the handwheel acceleration value and
$${J}_{h}^{*}$$
corresponds to a mechanical constant of inertia associated with a handwheel.

12. The method of claim 9, wherein the steering system is a steer-by-wire (SbW) steering system.

13. The method of claim 9, wherein obtaining the handwheel torque command value includes combining the estimation of system inertia with the reference torque.

14. The method of claim 13, wherein combining the estimation of system inertia with the reference torque includes subtracting the estimation of system inertia from the reference torque.

15. A processor configured to execute instructions stored in memory, wherein executing the instructions causes the processor to control a steering system by:
receiving a handwheel acceleration value;
generating an estimation of system inertia based on the handwheel acceleration value;
obtaining, based on the estimation of system inertia and a reference torque and without using a torque measurement received from a torque sensor, a handwheel torque command value; and
controlling at least one component of the steering system based on the handwheel torque command value.

16. The processor of claim 15, wherein the reference torque is based on an output of a driver effort function.

17. The processor of claim 15, wherein obtaining the handwheel torque command value includes obtaining the handwheel torque command value based on
$${τ}_{h} = {τ}_{r e f} - {J}_{h}^{*} {\ddot{θ}}_{h} ,$$
wherein τₕ is the handwheel torque command value, τ_{ref} is the reference torque, and
$${J}_{h}^{*} {\ddot{θ}}_{h}$$
represents the estimation of system inertia, and wherein \ddot{θ}ₕ corresponds to the handwheel acceleration value and
$${J}_{h}^{*}$$
corresponds to a mechanical constant of inertia associated with a handwheel.

18. The processor of claim 15, wherein the steering system is a steer-by-wire (SbW) steering system.

19. The processor of claim 15, wherein obtaining the handwheel torque command value includes combining the estimation of system inertia with the reference torque.

20. The processor of claim 19, wherein combining the estimation of system inertia with the reference torque includes subtracting the estimation of system inertia from the reference torque.
